(19) United States
(12) Patent Application Publication
(10) Pub. No.: US 2022/0327924 A1
(43) Pub. Date: Oct. 13, 2022

(54) TRAFFIC VOLUME BY ROUTE ESTIMATION DEVICE, TRAFFIC VOLUME BY ROUTE ESTIMATION METHOD, AND TRAFFIC VOLUME BY ROUTE ESTIMATION PROGRAM

(71) Applicant: NIPPON TELEGRAPH AND TELEPHONE CORPORATION, Tokyo (JP)

(72) Inventors: Koshin TO, Tokyo (JP); Akira NAKAYAMA, Tokyo (JP); Hisako SHIOHARA, Tokyo (JP); Shinya OI, Tokyo (JP); Yusuke TANAKA, Tokyo (JP); Masaru MIYAMOTO, Tokyo (JP)

(73) Assignee: NIPPON TELEGRAPH AND TELEPHONE CORPORATION, Tokyo (JP)

(21) Appl. No.: 17/613,045

(22) PCT Filed: May 23, 2019
(86) PCT No.: PCT/JP2019/020541

§ 371 Date: Nov. 20, 2021

(51) Int. Cl. G08G 1/065; G01C 21/34

(52) U.S. Cl. CPC G08G 1/065; G01C 21/3492

(57) ABSTRACT

A path specific traffic volume estimation unit (130) estimates a path specific traffic volume corresponding to a traffic volume of observation objects at each time point at each of path candidates on the basis of observation value data that represents the number of the observation objects at each time point at each of a plurality of observation spots, observation spot specific reliability data that represents a reliability of the observation value data at each time point at each of the plurality of observation spots, and a path candidate list that represents a set of the path candidates through which the observation objects move.

### TECHNICAL FIELD

A disclosed technology relates to a path specific traffic volume estimation device, a path specific traffic volume estimation method, and a path specific traffic volume estimation program.

### BACKGROUND ART

To cope with congestion that may occur in a large scale event or the like, understanding of a people flow, establishment of control measures, or the like has been conventionally performed by using a multi-agent simulator (MAS). For more accurate understanding of the people flow, establishment of effective control measures, or the like, a highly precise simulation is needed. For this reason, a technology for determining a parameter that reproduces observation value data on the basis of the observed data is essential. As such a parameter, for example, a parameter indicating the number of people who pass through a movement path is exemplified.

The observation value data mentioned herein refers to data temporally and spatially measured in a certain granularity and aggregated, for example, the number of people who pass through an observation spot j in a time slot t. The movement path represents a path through which an agent passes which also includes an origin and a destination. The MAS is executed for the agent when a departure time point and a movement path are specified, and is configured to output a passage spot and a passage time of each agent. In addition, as the parameter, for example, a vector obtained by arranging the number of agents passing through a path Rᵢ in a certain time slot t as represented as follows,

Xₜ=(X_{t,1},X_{t,2}, . . . ,X_{t,I}),

an I×J dimensional vector obtained by connecting those for the entire time slots as represented as follows,

X=(X₁,X₂, . . . ,Xₜ),

or the like is conceivable.

The movement path estimation at this time is considered as an optimization problem for a purpose of minimizing an error between an estimation value Y_{t, i}^{mas} obtained by aggregating outputs of the MAS and actual observation value data Y_{t, 1}^{obsv}.

An optimization technique is an approach for setting a parameter that should be searched for and an objective function in advance, and searching for a parameter at which a minimum value of the objective function is provided. In the optimization, various settings are conceivable by combinations of this parameter and the objective function.

In addition, there are roughly two conventional technologies related to the optimization, and a technique without using the MAS and a technique using the MAS are used for the optimization of a parameter X.

According to the technique without using the MAS, specifically, the estimation of the parameter X is performed while the observation value data and a path candidate are used as inputs, and the MAS is executed by using the estimated parameter X.

On the other hand, according to the technique using the MAS, specifically, a process is repeated for estimating the parameter X while the observation value data and the path candidate are used as inputs, and thereafter, calculating a new candidate of the parameter X by executing the MAS using the estimated X.

For example, a technology used in the technique using the MAS includes Bayesian optimization (Non-Patent Literature 1) or the like.

### CITATION LIST

### Non-Patent Literature

Non-Patent Literature 1: J. Snoek, H. Larochelle, and R. P. Adams. Practical Bayesian optimization of machine learning algorithms. In Advances in Neural Information Processing Systems (NIPS), 2012.

### SUMMARY OF THE INVENTION

### Technical Problem

As described above with regard to the related art technology, a plurality of combinations of the parameter as a target of the optimization and the objective function, and a plurality of techniques used for the optimization are conceivable.

However, when the observation value data is actually obtained, it is not necessary to be able to obtain data at all observation time points and all observation spots. For example, loss of the observation value data in only a particular time slot or at only a particular observation spot often occurs since obtainment is missed.

In addition, since the observation value data is affected by an influence of an observation error of equipment used for obtainment, when the optimization is performed, unless the influence of the observation error of such as the equipment is taken into account, the truly appropriate movement path estimation cannot be performed. For example, even when the observation targets are the same, in a case where a plurality of obtainment methods are present and those observation errors differ, differences of the observation errors of the respective obtainment methods need to be taken into account. For example, in a case where the observation target is people flow, when a camera, the number of people passing through a gate, an infrared sensor, and the like are used as the plurality of obtainment methods, the observation errors of the respective obtainment methods differ.

In addition, an influence of an installment location or a time slot may occur even in the same obtainment method. For example, even when the same camera is used, a recognition rate is higher in daytime than that in night.

For this reason, to perform the appropriate movement path estimation, it is necessary to take into account how reliable data obtained for each time slot and each observation spot is (hereinafter, referred to as reliability).

A disclosed technology has been made in view of the aforementioned aspect, and it is an object to provide a path specific traffic volume estimation device that can precisely estimate a path specific traffic volume even under a situation where the reliability of the observation value data varies for each time slot or each observation spot, a path specific traffic volume estimation method, and a path specific traffic volume estimation program.

### Means for Solving the Problem

A first aspect of the present disclosure is a path specific traffic volume device that includes a path specific traffic volume estimation unit configured to estimate a path specific traffic volume corresponding to a traffic volume of observation objects at each time point at each of path candidates on the basis of observation value data that represents the number of the observation objects at each time point at each of a plurality of observation spots, observation spot specific reliability data that represents a reliability of the observation value data at each time point at each of the plurality of observation spots, and a path candidate list that represents a set of the path candidates through which the observation objects move.

A second aspect of the present disclosure is a path specific traffic volume device that includes a simulator execution unit configured to execute a simulation in which agents representing observation objects move at each time point on the basis of an input parameter configured by observation value data that represents the number of the observation objects at each time point at each of a plurality of observation spots, observation spot specific reliability data that represents a reliability of the observation value data at each time point at each of the plurality of observation spots, a path candidate list that represents a set of path candidates through which the observation objects move, and a traffic volume of the observation objects at each time point at each of the path candidates, and calculate, by using the observation spot specific reliability data, an error between a calculation value obtained by estimating the number of the agents at each time point at each of the plurality of observation spots and the observation value data, a next input parameter determination unit configured to determine a next input parameter on the basis of the input parameter and the error, and an optimization control unit configured to estimate the traffic volume of the observation objects at each time point at each of the path candidates by repeating, until a predetermined repetition ending condition is satisfied, the execution of the simulation by the simulator execution unit and the determination of the next input parameter by the next input parameter determination unit.

A third aspect of the present disclosure is a path specific traffic volume estimation method that includes causing a path specific traffic volume estimation unit to estimate a path specific traffic volume corresponding to a traffic volume of observation objects at each time point at each of path candidates on the basis of observation value data that represents the number of the observation objects at each time point at each of a plurality of observation spots, observation spot specific reliability data that represents a reliability of the observation value data at each time point at each of the plurality of observation spots, and a path candidate list that represents a set of the path candidates through which the observation objects move.

A fourth aspect of the present disclosure is a path specific traffic volume estimation method that includes causing a simulator execution unit to execute a simulation in which agents representing observation objects move at each time point on the basis of an input parameter configured by observation value data that represents the number of the observation objects at each time point at each of a plurality of observation spots, observation spot specific reliability data that represents a reliability of the observation value data at each time point at each of the plurality of observation spots, a path candidate list that represents a set of path candidates through which the observation objects move, and a traffic volume of the observation objects at each time point at each of the path candidates, and calculate, by using the observation spot specific reliability data, an error between a calculation value obtained by estimating the number of the agents at each time point at each of the plurality of observation spots and the observation value data, causing a next input parameter determination unit to determine a next input parameter on the basis of the input parameter and the error, and causing an optimization control unit to estimate the traffic volume of the observation objects at each time point at each of the path candidates by repeating, until a predetermined repetition ending condition is satisfied, the execution of the simulation by the simulator execution unit and the determination of the next input parameter by the next input parameter determination unit.

A fifth aspect of the present disclosure is a path specific traffic volume estimation program for causing a computer to estimate a path specific traffic volume corresponding to a traffic volume of observation objects at each time point at each of path candidates on the basis of observation value data that represents the number of the observation objects at each time point at each of a plurality of observation spots, observation spot specific reliability data that represents a reliability of the observation value data at each time point at each of the plurality of observation spots, and a path candidate list that represents a set of the path candidates through which the observation objects move.

A sixth aspect of the present disclosure is a path specific traffic volume estimation program for causing a computer to execute a simulation in which agents representing observation objects move at each time point on the basis of an input parameter configured by observation value data that represents the number of the observation objects at each time point at each of a plurality of observation spots, observation spot specific reliability data that represents a reliability of the observation value data at each time point at each of the plurality of observation spots, a path candidate list that represents a set of path candidates through which the observation objects move, and a traffic volume of the observation objects at each time point at each of the path candidates, and calculate, by using the observation spot specific reliability data, an error between a calculation value obtained by estimating the number of the agents at each time point at each of the plurality of observation spots and the observation value data, determine a next input parameter on the basis of the input parameter and the error, and estimate the traffic volume of the observation objects at each time point at each of the path candidates by repeating, until a predetermined repetition ending condition is satisfied, the execution of the simulation and the determination of the next input parameter.

### Effects of the Invention

According to the disclosed technology, even under a situation where the reliability of the observation value data differs for each time slot or each observation spot, the path specific traffic volume can be precisely estimated.

### BRIEF DESCRIPTION OF DRAWINGS

FIG. 1 is a schematic block diagram of an example of a computer that functions as a path specific traffic volume estimation device of a first embodiment and a second embodiment.

FIG. 2 is a block diagram illustrating a configuration of the path specific traffic volume estimation device of the first embodiment.

FIG. 3 is an example of observation value data.

FIG. 4 is a flowchart illustrating a path specific traffic volume estimation processing routine of the path specific traffic volume estimation device of the first embodiment.

FIG. 5 is an explanatory diagram for describing a parameter optimization method.

FIG. 6 is a block diagram illustrating a configuration of the path specific traffic volume estimation device of the second embodiment.

FIG. 7 is a block diagram illustrating a configuration of an optimization execution unit of the path specific traffic volume estimation device of the second embodiment.

FIG. 8 is a flowchart illustrating a path specific traffic volume estimation processing routine of the path specific traffic volume estimation device of the second embodiment.

FIG. 9 is a flowchart illustrating an optimization processing routine of the path specific traffic volume estimation device of the second embodiment.

### DESCRIPTION OF EMBODIMENTS

Hereinafter, an example of an embodiment of a disclosed technology will be described with reference to the drawings. It should be noted that the same or equivalent components and parts in the respective drawings are assigned with the same reference signs. In addition, dimensional ratios of the drawings are magnified for convenience of descriptions, and may be different from actual ratios.

Hereinafter, a path specific traffic volume estimation device 10 configured to estimate the number of people as a path specific traffic volume will be described in an example. It should be noted however that the path specific traffic volume is not limited to the number of people for each path. For example, it may be the number of vehicles for each path, the number of motorbikes for each path, the number of bicycles for each path, the number of individual pieces of living matters for each path, and the like. Therefore, the path specific traffic volume estimation device 10 according to the present embodiment can also be similarly applied to a case where these path specific traffic volumes are estimated. Thus, the people, the vehicles, the motorbikes, the bicycles, the living matters, and the like that move through the path may be referred to as “observation objects”.

### First Embodiment

### <Configuration of the Path Specific Traffic Volume Estimation Device of the First Embodiment>

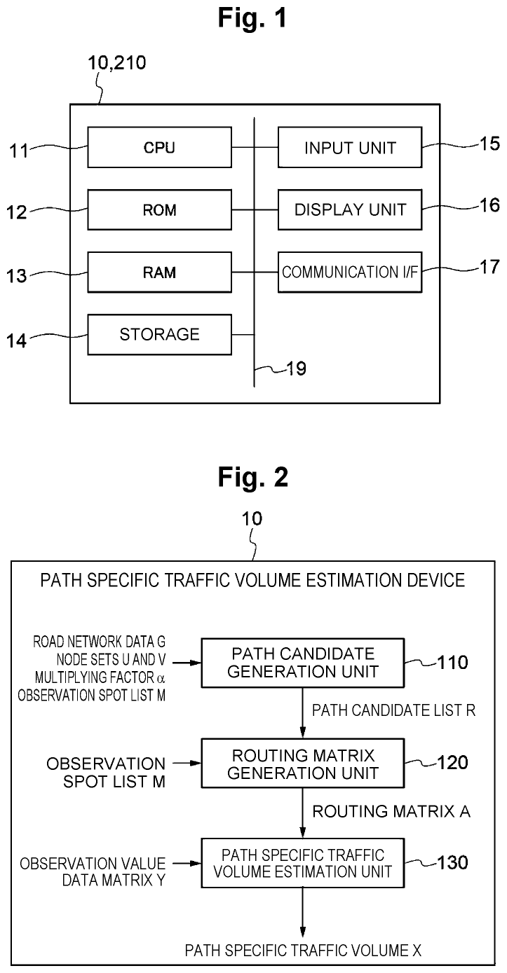

FIG. 1 is a block diagram illustrating a hardware configuration of the path specific traffic volume estimation device 10 of the present embodiment.

As illustrated in FIG. 1, the path specific traffic volume estimation device 10 has a central processing unit (CPU) 11, a read only memory (ROM) 12, a random access memory (RAM) 13, a storage 14, an input unit 15, a display unit 16, and a communication interface (I/F) 17. The respective configurations are mutually connected to be communicable via a bus 19.

The CPU 11 is a central processing unit, and is configured to execute various programs and control various units. That is, the CPU 11 reads out a program from the ROM 12 or the storage 14, and executes the program by using the RAM 13 as a work area. The CPU 11 performs control of the aforementioned respective configurations and various calculation processes according to the program stored in the ROM 12 or the storage 14. According to the present embodiment, the ROM 12 or the storage 14 stores a path specific traffic volume estimation program for estimating the path specific traffic volume. The path specific traffic volume estimation program may be a single program or may also be a program group configured by a plurality of programs or modules.

The ROM 12 stores various programs and various data. The RAM 13 temporarily stores programs or data as a work area. The storage 14 is configured by a hard disk drive (HDD) or a solid state drive (SSD), and stores various programs including an operating system, and various data.

The input unit 15 includes a pointing device such as a mouse, and a keyboard, and is used to input various inputs.

The display unit 16 is, for example, a liquid crystal display, and displays various information. The display unit 16 may also function as the input unit 15 by adopting a touch panel method.

The communication interface 17 is an interface configured to communicate with another equipment, and for example, a standard such as Ethernet (registered trademark), FDDI, or Wi-Fi (registered trademark) is used.

Next, functional configurations of the path specific traffic volume estimation device 10 will be described.

FIG. 2 is a block diagram illustrating an example of a functional configuration of the path specific traffic volume estimation device 10.

As illustrated in FIG. 2, the path specific traffic volume estimation device 10 has, as functional configurations, a path candidate generation unit 110, a routing matrix generation unit 120, and a path specific traffic volume estimation unit 130. The respective functional configurations are realized when the CPU 11 reads out the path specific traffic volume estimation program stored in the ROM 12 or the storage 14 to develop and execute the program in the RAM 13.

<Definitions of Variables>

Herein, respective variables used according to the present embodiment will be defined as below.
X_{t, i} denotes an estimation value of the path specific traffic volume.
t denotes an index indicating a time point. Where, t satisfies 0≤t≤T.
T denotes a last time point in a time slot set as an observation target.
Rᵢ denotes a path candidate (node string through which the observation object may pass).
i denotes an index of the path candidate. Where, i satisfies 1≤i≤I.
I denotes the number of path candidates.
Y_{t, j} denotes observation spot specific people count observation value data.
Mⱼ denotes an observation spot (node string serving as the observation target).
j denotes an index of the observation spot. Where j satisfies 1≤j≤J.
J denotes the number of the observation spots.
A denotes a routing matrix.
W_{t, j} denotes observation spot specific reliability data.
   Where 0≤W_{t, j}≤1.

Herein, a T-row J-column matrix in which the observation spot specific people count observation value data Y_{t, j} is set as each element is represented as an observation value data matrix Y. The observation value data matrix Y refers to data in which traffic volume is temporally and spatially measured in a certain granularity and aggregated. As a method of obtaining the observation value data matrix Y, a method of measuring traffic volume by counting the number of passing vehicles or people by using, for example, a camera, the number of people passing through a gate, an infrared sensor, and the like is exemplified.

Herein, the T-row J-column matrix in which the observation spot specific reliability data W_{t, j} is set as each element is represented as a reliability matrix W. The reliability matrix W, in which each element corresponds to the observation value data matrix Y, represents the reliability of the observation value data measured at each of the observation spots. Herein, the reliability matrix W is defined while 0≤W_{t, j}≤1 is set, and for example, the reliability matrix may be equivalent to a variance related to a value of the observation value data Y_{t, j}, or may also represent a parameter representing an error distribution. According to the present embodiment, an example of a case is exemplified where 0≤W_{t, j}≤1 is set.

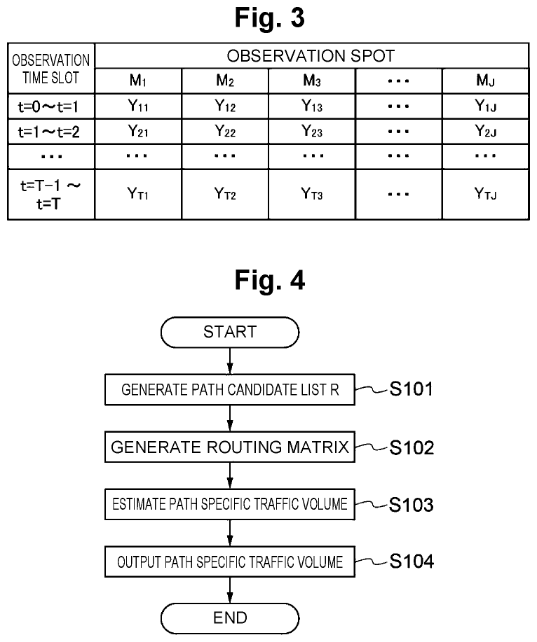

FIG. 3 illustrates an example of the observation value data matrix Y and the reliability matrix W. In the observation value data matrix Y, the observation value data Y_{1, j} (j=1, 2, . . . , J) observed in the observation time slot (observation period) between t=0 and t=1 at the observation spot Mⱼ (j=1, 2, . . . , J) is set as an element of a (1, j) component. Similarly, in the observation value data matrix Y, the observation value data Y_{2, j} (j=1, 2, . . . , J) observed in the observation time slot between t=1 and t=2 at the observation spot Mⱼ (j=1, 2, . . . , J) is set as an element of a (2, j) component. Subsequently too, similarly, in the observation value data matrix Y, the observation value data Y_{t, j} (j=1, 2, . . . , J) observed in the observation time slot between t=T−1 and t=T at the observation spot Mⱼ (j=1, 2, . . . , J) is set as the element of the (T, j) component.

Similarly as in the observation value data matrix Y, the reliability matrix W also corresponds to each combination of T×J in the observation time slot 1 to T at the observation spot Mⱼ (j=1, 2, . . . , J), the reliability data W_{t, j} corresponds to the observation value data Y_{t, j}, and W_{t, j} takes a value equal to or higher than 0 and equal to or lower than 1. W_{t, j} represents the reliability of the observation value data Y_{t, j}, and in a case where Y_{t, j} is a missing value, W_{t, j}=0 is set, and in a case where it is regarded that an observation error of Y_{t, j} does not exist, W_{t, j}=1 is set.

It should be noted that the time widths at the respective observation times may differ from each other. For example, the time width between the observation times t=0 and t=1 may be different from the time width between the observation times t=1 and t=2. In addition, the observation may be performed at different time widths for each observation spot Mⱼ. For example, during a period from t=0 to t=T, the observation is performed T times at the observation spot M₁, and the observation is performed T/2 times at the observation spot M₂, or the like. In other words, the observation cycle may differ for each observation spot Mⱼ. In this case, the observation value data matrix Y may be represented by a plurality of matrices by organizing for each observation spot Mⱼ with the matching time width of the observation, that is, organizing for each observation spot Mⱼ with the same observation cycle.

Next, a path candidate generation principle by the path candidate generation unit 110 will be described.

The path candidate generation unit 110 generates a path candidate list R by using road network data G, a node set V and a node set U, a multiplying factor α, and an observation spot list M as inputs. The path candidate list R is a list of the path candidate Rᵢ. It should be noted however that the path candidate Rᵢ is a node string in which a link exists in the road network data G.

It should be noted that at least one of the node set V and the node set U, the multiplying factor α, and the observation spot list M is not input to the path candidate generation unit 110. That is, the node set V and the node set U, the multiplying factor α, and the observation spot list M is optional input data.

Instead of the use of the path candidate generation unit 110, a substitution may be made by inputting the path candidate list in advance. Hereinafter, a case where the path candidate generation unit 110 is used will be described.

The road network data G is a directed graph representing a road network as a target. The road network data G is represented as G={N, E} while a set of nodes (for example, junctions and the like) belonging to the road network is set as N, and a set of links (for example, roads and the like) belonging to the road network is set as E.

The node set V and the node set U are a set of nodes for limiting a combination of an origin and a destination (hereinafter, referred to as an “OD combination”). The OD combination is a combination of a node corresponding to the origin and a node corresponding to the destination.

As the node included in the node set V and the node set U, a node indicating a landmark (for example, a node where a person may appear or disappear) is exemplified. Specifically, for example, a set of nodes indicating stations, a set of nodes indicating entrances of event halls, and the like are exemplified.

The multiplying factor α is a value for limiting a permitted range of a course of the path candidate Rᵢ. The value of the multiplying factor α is set in advance, for example, by a user of the path specific traffic volume estimation device 10 or the like.

The observation spot list M is a list of the observation spot Mⱼ for excluding the path candidate Rᵢ that is not observed at any observation spot Mⱼ.

Specifically, the path candidate generation unit 110 executes the following (Procedure 1) to (Procedure 4) on all the OD combinations to generate the path candidate list R. In a case where the node set V and the node set U are not input, the path candidate generation unit 110 creates the OD combination from nodes included in the road network data G. On the other hand, in a case where the node set V and the node set U are input, the path candidate generation unit 110 creates the OD combination from nodes included in the node set V and nodes included in the node set U. The creation of the OD combination from the nodes included in the node set V and the nodes included in the node set U is equivalent to selection of each edge of a complete bipartite graph by the node set V and the node set U.

It should be noted that any of the nodes included in the road network data G, the nodes included in the node set V, and the nodes included in the node set U may be set as either the origin or the destination. That is, with regard to a node N₁ and a node N₂ included in the road network data G, a combination in which the node N₁ is set as the origin and the node N₂ is set as the destination, and a combination in which the node N₂ is set as the origin and the node N₁ is set as the destination exist as the OD combinations. Similarly, with regard to the node N₁ included in the node set V and the node N₂ included in the node set U, a combination in which the node N₁ is set as the origin and the node N₂ is set as the destination, and a combination in which the node N₂ is set as the origin and the node N₁ is set as the destination exist as the OD combinations.

(Procedure 1) The path candidate generation unit 110 counts up all paths between a node indicating the origin included in the OD combination (hereinafter, referred to as a “node O”) and a node indicating the destination included in the OD combination (hereinafter, referred to as a “node D”). Each of the enumerated paths is the path candidate Rᵢ.

Enumeration of all paths between the node O and the node D can be performed by using, for example, Graphillion. Graphillion is disclosed in, for example, ERATO Minato Discrete Structure Manipulation System Project, Shin-ichi Minato, “Chokosoku Gurafu rekkyo arugorizumu—<Fukashigi no Kazoekata> ga Hiraku, Kumiawase Mondai heno Shin Apurochi (Super High-Speed Graph Enumeration Algorithms—Novel Approach to Combinatorial Problem Developed by <Mysterious Enumeration>) (in Japanese)”, Morikita Publishing Co., Ltd., 2015.

(Procedure 2) The path candidate generation unit 110 searches for a shortest path between the node O and the node D by a shortest path search algorithm, and calculates a distance of the shortest path that has been searched for. For this, NetworkX corresponding to a Python library or the like can be used.

(Procedure 3) Next, the path candidate generation unit 110 compares the distance (path candidate distance dᵢ) of each path candidate Rᵢ obtained by the aforementioned (Procedure 1) with the distance (shortest distance dₘᵢₙ) of the shortest path obtained by the aforementioned (Procedure 2). Then, the path candidate generation unit 110 excludes the path candidate Rᵢ in which the path candidate distance dᵢ is α times or more as long as the shortest distance dₘᵢₙ among the respective path candidates Rᵢ.

(Procedure 4) Next, the path candidate generation unit 110 excludes the path candidate Rᵢ that is not observed among the path candidates Rᵢ obtained by the aforementioned (Procedure 3). Whether or not the path candidate Rᵢ is observed can be determined by using the observation spot list M.

More specifically, for example, the observation spot Mⱼ included in the observation spot list M is set as Mⱼ=[M_{j, 1}, M_{j, 2}, . . . , M_{j, n}], and the path candidate Rᵢ is set as Rᵢ=[R_{i, 1}, R_{i, 2}, . . . , R_{i, k}]. Where n denotes the number of nodes included in the observation spot Mⱼ, and k denotes the number of nodes included in the path candidate Rᵢ. At this time, in a case where any node among R_{i, 1}, R_{i, 2}, . . . , R_{i, k} is the same node as any node of M_{j, 1}, M_{j, 2}, . . . , M_{j, n}, it is determined that the path candidate Rᵢ is observed. On the other hand, in a case where any node among R_{i, 1}, R_{i, 2}, . . . , R_{i, k} is not the same node as any node among M_{j, 1}, M_{j, 2}, . . . , M_{j, n}, it is determined that the path candidate Rᵢ is not observed.

In particular, in a case where a head node R_{i, 1} of the path candidate Rᵢ is the same node as any node among M_{j, 1}, M_{j, 2}, . . . , M_{j, n}, the departure of the path candidate Rᵢ is observed. Similarly, in a case where a tail node R_{i, k} of the path candidate Rᵢ is the same node as any node among M_{j, 1}, M_{j, 2}, . . . , M_{j, n}, the arrival of the path candidate Rᵢ is observed. In addition, in a case where the observation spot Mⱼ is a substring of the path candidate Rᵢ, the passage of the path candidate Rᵢ is observed.

The list of the path candidate Rᵢ obtained by the aforementioned (Procedure 4) for all the OD combinations is the path candidate list R. Then, the path candidate generation unit 110 outputs the obtained path candidate list R to the routing matrix generation unit 120.

It should be noted that as described above, at least one of the node set V and the node set U, the multiplying factor α, and the observation spot list M is not input to the path candidate generation unit 110. It should be noted however that depending on a size of the road network data G, the number of the path candidates Rᵢ included in the path candidate list R may be very high. For this reason, the path candidate Rᵢ is preferably limited by using at least one of the node set V and the node set U, the multiplying factor α, and the observation spot list M.

The routing matrix generation unit 120 generates the routing matrix A by using the path candidate list R and the observation spot list M as the inputs.

Specifically, when each element of the routing matrix A is set as A_{j, i}, the routing matrix A is a zero one matrix as follows.
In a case where a person in the path candidate Rᵢ is observed at the observation spot Mⱼ, A_{j, i}=1 is set.
In a case where the person in the path candidate Rᵢ is not observed at the observation spot Mⱼ, A_{j, i}=0 is set.

It should be noted that as a type of the observation, at least one of a case where the departure is observed, a case where the arrival is observed, and a case where the passage is observed can be used.

For example, the path candidate Rᵢ is set as Rᵢ=[R_{i, 1}, R_{i, 2}, . . . , R_{i, k}]. Where k denotes the number of nodes included in the path candidate Rᵢ. The observation spot Mⱼ included in the observation spot list M is set as Mⱼ=[M_{j, 1}, M_{j, 2}, . . . , M_{j, n}]. Where n denotes the number of nodes included in the observation spot Mⱼ. The observation spot Mⱼ has any one of attributes “departure”, “arrival”, and “passage”. In the case of “departure”, it is represented that a head element (head node) R_{i, 1} of the path candidate Rᵢ is included in the observation spot Mⱼ. In the case of “arrival”, it is represented that a tail element R_{i, k} of the path candidate Rᵢ is included in the observation spot Mⱼ. In the case of “passage”, it is represented that at least a part of the path candidate Rᵢ is included in the observation spot Mⱼ. Then, the observation spot list M includes the observation spot Mⱼ with at least one attribute of “departure”, “arrival”, and “passage”. When the path candidate Rᵢ is observed at the observation spot Mⱼ, the routing matrix A is generated such that the (j, i) element A_{j, i} of the routing matrix is 1.

The thus generated respective elements of the routing matrix A represent whether or not the observation objects passing through each of a plurality of paths (for example, a person, a car, a motorbike, a bicycle, and the like) are observed at each of the plurality of observation spots. In other words, A_{j, i} represents whether or not the observation object passing through the path candidate Rᵢ can be observed at the observation spot Mⱼ. According to this, at the time of the estimation of the number of the observation objects passing through the path candidate Rᵢ, the routing matrix A identifies which element in the observation value data Y should be taken into account.

The path specific traffic volume estimation unit 130 estimates a path specific traffic volume matrix X by using the routing matrix A, the observation value data matrix Y, and the reliability matrix W as the inputs. Then, the path specific traffic volume estimation unit 130 outputs the estimated path specific traffic volume matrix X. The path specific traffic volume matrix X is a matrix using the path specific traffic volume at each time point at each of the path candidates as the element.

Specifically, the path specific traffic volume estimation unit 130 executes the following (Procedure 1) to (Procedure 4) to estimate the path specific traffic volume matrix X from the routing matrix A and the observation value data matrix Y.

(Procedure 1) The path specific traffic volume estimation unit 130 shapes the observation value data matrix Y to generate an observation value data matrix S. The observation value data matrix S after the shaping is a D-row 4-column matrix, and the d-th row is [M_{d}, U_{d}, Y_{d}′, W_{d}′]. Herein, D denotes the number of the observation value data Y_{t, j} obtained by excluding the missing value from the observation value data Y_{t, j} included in the observation value data matrix Y. In other words, D denotes the number of elements of the observation value data Y_{t, j} that is not a missing value among the observation value data Y_{t, j} included in the observation value data matrix Y. The observation value data matrix S is obtained by sequentially reassigning an index from 1 to the observation value data Y_{t, j} that is not the missing value, and converting a value for each of the respective elements also including the reliability matrix W into [M_{d}, U_{d}, Y_{d}′, W_{d}′].

M_{d} is an index of the observation spot of the d-th (d=1, 2, . . . , D) observation value data Y_{d}′, and 1≤M_{d}≤J is set. U_{d} denotes information representing an observation time slot (observation period) of the observation value data Y_{d}′, and is a list of a time segment (unit time) tᵢ equivalent to the time slot when the d-th observation value data Y_{d}′ is observed while the time slot separated every predetermined time width ΔT is set as tₖ (k=1, 2, . . . ). Hereinafter, ΔT will be referred to as an observation time width.

For example, in a case where certain observation value data Y_{d}′ is obtained by observing the time slot represented by t₂ to t₄, the value U_{d}={t₂, t₃, t₄} is set. Similarly, in a case where other certain observation value data Y_{d}′ is obtained by observing the time slot represented by t₃ to t₄, the value U_{d}={t₃, t₄} is set.

It should be noted that the observation time width ΔT is preferably set to be sufficiently small. When the observation time width ΔT is set to be sufficiently small, even in a case where plural pieces of the observation value data Y_{t, j} with different time widths of the observation time slots are used or a case where observation time slots having different time widths exist in the single observation value data Y_{t, j}, it is possible to generate the observation value data matrix S in which all the observation times are taken into account. Specifically, for example, in a case where the observation time slot in which the time width is “10 minutes” and the observation time slot in which the time width is “15 minutes” exist, the observation value data matrix S is generated while ΔT is set as “5 minutes” corresponding to a common denominator of the time widths of all the observation time slots. In other words, times obtained by dividing all of the respective observation periods of the observation value data matrix Y into predetermined observation time widths are set as unit times t₁, t₂, . . . , t_{T}, and the value obtained by representing again, that is, normalizing, each of the respective observation periods by combinations of one or more unit times is U_{d}. Then, the observation value data matrix S is data obtained by removing the missing value from the observation value data matrix Y to be shaped again into a form where the observation value for each normalized observation period U_{d} and each observation spot can be specified. According to this, even in a case where the observation value data Y_{t, j} with a different observation period or a different observation cycle of the traffic volume is supplied, a case where the observation value data Y_{t, j} with a shift in the observation period or the observation cycle of the traffic volume is supplied, or the like, it is possible to accommodate the difference in the observation period or the shift in the observation cycle.

(Procedure 2) Next, the path specific traffic volume estimation unit 130 generates the observation matrix H while each element of the observation matrix H is set as H_{d, t} in the following manner.
In a case where t is included in the observation period U_{d}, H_{d, t}=A_{Md} is set.
In a case where t is included in the observation period U_{d}, H_{d, t}=0 is set.

Herein, A_{Md} denotes 1×I matrix in which the M_{d}-th row elements of a the routing matrix A are arranged. In addition, H_{d, t}=0 in a case where t is not included in the observation period U_{d} is not scalar, and represents a 1×I matrix in which each element is 0. As a result, the observation matrix H is a D×(I×T) matrix.

(Procedure 3) Next, the path specific traffic volume estimation unit 130 obtains a vector X′ for minimizing an objective function L indicated by the following equation.

$$\begin{matrix}[ Math . 1 ] & \\ \begin{matrix}L = \vert < {W}^{′} , {Y}^{′} - {HX}^{′} > \vert \\ = {\sum }_{d} {( < {W}_{d}^{′} , {Y}_{d}^{′} - {\sum }_{t} {H}_{d , t} {X}_{t}^{′} > )}^{2} \\ = {\sum }_{d} {( < {W}_{d}^{′} , {Y}_{d}^{′} - {\sum }_{t ∈ {U}_{d}} {A}_{{M}_{d}} {X}_{t}^{′} > )}^{2} \\ = {\sum }_{d} {( < {W}_{d}^{′} , {Y}_{d}^{′} - {\sum }_{t ∈ {U}_{d}} {A}_{{M}_{d}} {X}_{t}^{′} > )}^{2}\end{matrix} & ( 1 )\end{matrix}$$

Where <W′, Y′> represents an inner product. In addition, since the number of people is nonnegative, the objective function L is minimized so as to satisfy a restriction condition X_{t, i}′≥0. In other words, an (I×T) dimensional vector X′ that satisfies Y′=HX′ is obtained.

As a technique for obtaining the vector X′ for minimizing the aforementioned equation (1), for example, a trust region reflective algorithm or the like may be used. The trust region reflective algorithm is disclosed, for example, in Coleman, T. F. and Y. Li. “A Reflective Newton Method for Minimizing a Quadratic Function Subject to Bounds on Some of the Variables,” SIAM Journal on Optimization, Vol. 6, Number 4, pp. 1040-1058, 1996, or the like.

(Procedure 4) Next, the path specific traffic volume estimation unit 130 converts the (I×T) dimensional vector X′ obtained in the aforementioned (Procedure 3) into a T-row I-column matrix X by sequentially arranging I elements each time from the head element in one row. This matrix X is the path specific traffic volume matrix X. The (t, i) element of the path specific traffic volume matrix X is an estimation result of the number of people who passes through the path Rⱼ at the time point t.

The path specific traffic volume estimation unit 130 outputs the path specific traffic volume matrix X by the display unit 16.

<Action of the Path Specific Traffic Volume Estimation Device of the First Embodiment>

Next, an action of the path specific traffic volume estimation device 10 will be described.

FIG. 4 is a flowchart illustrating a flow of the path specific traffic volume estimation processing by the path specific traffic volume estimation device 10. The CPU 11 reads out the path specific traffic volume estimation program from the ROM 12 or the storage 14, and develops and executes the program in the RAM 13 to perform the path specific traffic volume estimation processing.

In step S101, the CPU 11 functioning as the path candidate generation unit 110 generates the path candidate list R by using the road network data G, the node set V and the node set U, the multiplying factor α, and the observation spot list M as the inputs.

In step S102, the CPU 11 functioning as the routing matrix generation unit 120 generates the routing matrix A by using the path candidate list R and the observation spot list M as the inputs.

In step S103, the CPU 11 functioning as the path specific traffic volume estimation unit 130 estimates the path specific traffic volume matrix X by using the routing matrix A, the observation value data matrix Y, and the reliability matrix W as the inputs.

In step S104, the CPU 11 functioning as the path specific traffic volume estimation unit 130 outputs the path specific traffic volume matrix X by the display unit 16, and the path specific traffic volume estimation processing is ended.

As described above, the path specific traffic volume estimation device according to the first embodiment estimates the path specific traffic volume on the basis of the observation value data, the observation spot specific reliability data, and the path candidate list. The observation value data is the number of observation objects at each time point at each of the plurality of observation spots. The observation spot specific reliability data is the reliability of the observation value data at each time point at each of the plurality of observation spots. The path candidate list represents a set of path candidates through which the observation objects move. The path specific traffic volume is the traffic volume of the observation objects at each time point at each of the path candidates. According to this, even under a situation where the reliability of the observation value data varies for each time slot or each observation spot, the path specific traffic volume can be precisely estimated.

### Second Embodiment

Next, a path specific traffic volume estimation device according to a second embodiment will be described. It should be noted that the same reference sign is assigned to a part having a similar configuration as that of the first embodiment, and descriptions will be omitted.

<Outline of a Movement Path Estimation Device According to the Second Embodiment>

First, outline of the second embodiment will be described.

According to the present embodiment, a people flow simulator is used for the optimization of the path specific traffic volume matrix X.

In an example of the embodiment, “the number of observation objects passing through each path Rᵢ in one time slot t”

Xₜ=(X_{t,1},X_{t,2}, . . . ,X_{t,I}), and

“the reliability of the observation value data observed at the respective observation spots (J in total) in one time slot t”

Wₜ=(W_{t,1},W_{t,2}, . . . ,W_{t,J})

are used as input parameters of the people flow simulator.

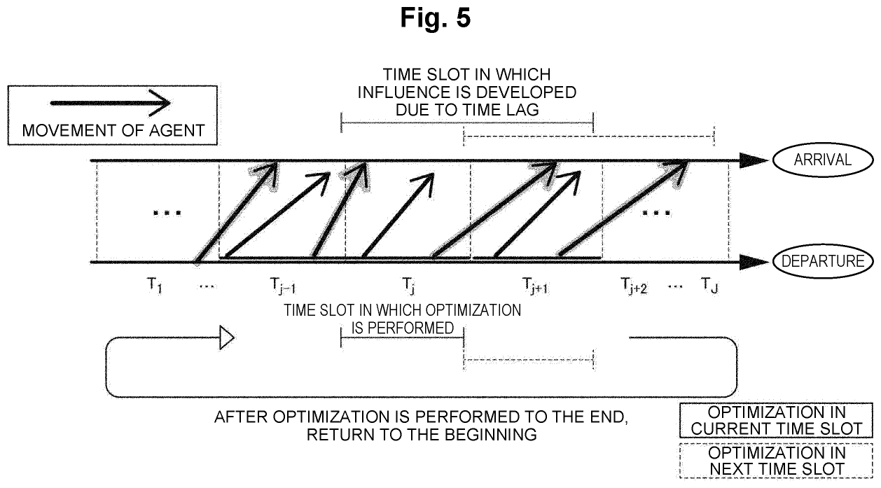

The objective function also uses the observation error at the same time slot, and the measurement errors in the following time slot and subsequent time slots in which an influence is developed due to time lag. FIG. 5 is an image diagram illustrating an outline of the present embodiment.

In other words, according to the present embodiment, the number of the observation objects passing through each path at each time slot is obtained by solving an optimization problem in the following equation.

$$\begin{matrix}[ Math . 2 ] & \\ {X}_{t}^{⋆} = {argmin}_{{X}_{t}} {L}^{( t , t + D )} ( {X}_{t} , {W}_{t} ) & \end{matrix}$$

Where D denotes the number of spent time slots at a maximum since the observation object is generated and until the observation object is observed. Since D represents how much the observation object is delayed, D can be appropriately changed according to a situation. In addition, L^{(t, t+D)} (Xₜ, Wₜ) is represented, for example, in a form of a multiplication of a weight Wₜ by L^{(t, t+D)} (Xₜ) corresponding to an objective function without the weight as described below.

L^{(t,t+D)}(Xₜ,Wₜ)=WₜL^{(t,t+D)}(Xₜ)

When the objective function is set as L^{(t, t+D)} (Xₜ, Wₜ), since the observation error at the time slot in which an influence is developed due to the time lag by the observation object generated at the time slot Tⱼ can also be taken into account while the reliability of the observation value data observed at each observation spot is taken into account, the movement path of the observation object can be highly precisely estimated.

<Configuration of the Path Specific Traffic Volume Estimation Device of the Second Embodiment>

As illustrated in FIG. 1 described above, a hardware configuration of a path specific traffic volume estimation device 210 of the present embodiment is similar to that of the path specific traffic volume estimation device 10 of the first embodiment.

Next, functional configurations of the path specific traffic volume estimation device 210 will be described.

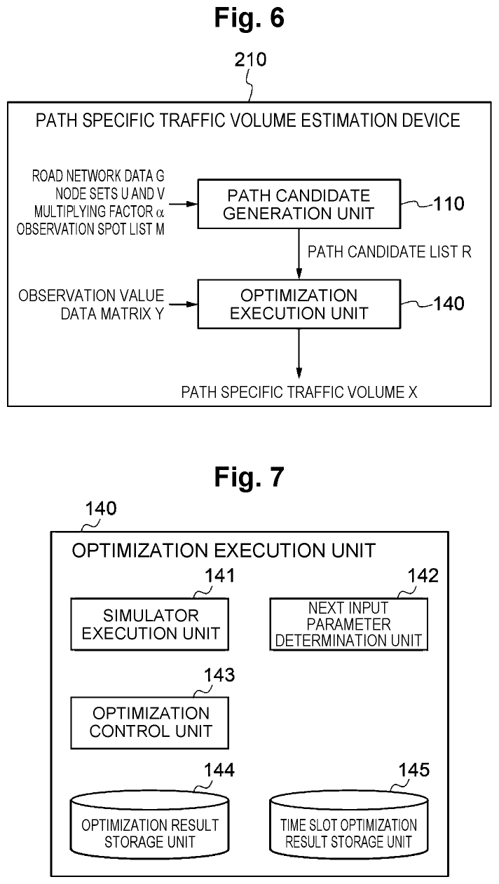

FIG. 6 is a block diagram illustrating an example of a functional configuration of the path specific traffic volume estimation device 210.

As illustrated in FIG. 6, the path specific traffic volume estimation device 210 has, as functional configurations, the path candidate generation unit 110, and an optimization execution unit 140.

The optimization execution unit 140 obtains the input parameter Xₜ for optimizing the objective function L^{(t, t+D)} (Xₜ, Wₜ).

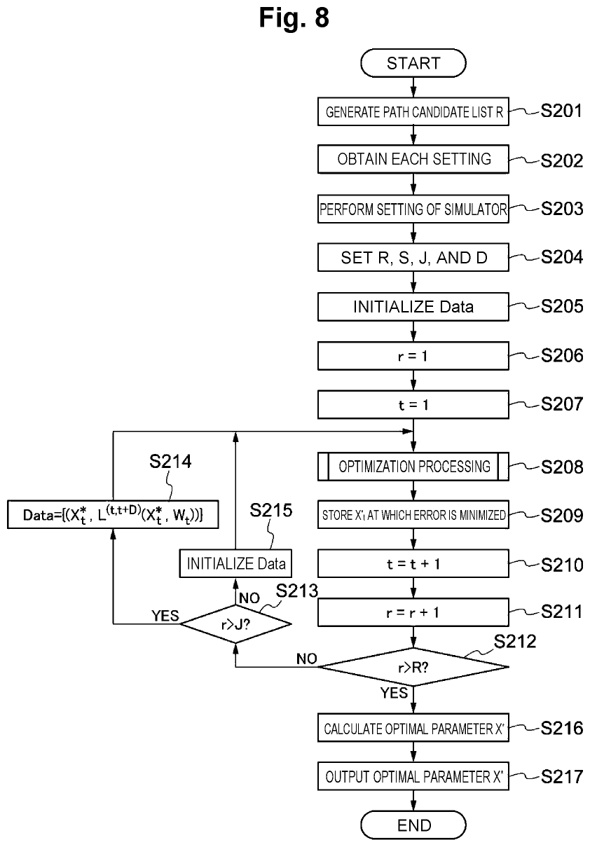

Specifically, as illustrated in FIG. 7, the optimization execution unit 140 is provided with a simulator execution unit 141, a next input parameter determination unit 142, an optimization control unit 143, an optimization result storage unit 144, and a time slot optimization result storage unit 145.

The simulator execution unit 141 executes a simulation in which, with regard to each of the plurality of paths Rᵢ in the actual environment, a plurality of agents representing observation objects move at each time slot t by using the people flow simulator on the basis of “the number of observation objects passing through each path Rᵢ in one time slot t”

Xₜ=(X_{t,1},X_{t,2}, . . . ,X_{t,I}), and

“the reliability of the observation value data observed at the respective observation spots (J in total) in the one time slot t”

Wₜ=(W_{t,1},W_{t,2}, . . . ,W_{t,J}).

The simulator execution unit 141 calculates an objective function value L^{(t, t+D)} (Xₜ, Wₜ) representing an observation error between the calculation value Wₜ, ᵢYₜ, i^{mas} related to the agent representing the observation object at each of the observation spots and the actual observation value Wₜ, ᵢYₜ, i^{obsv} in a predetermined number of time slots including an estimation target time slot t and the next time slot t+D after the estimation target time slot from the simulation result. The simulator execution unit 141 stores the pair (Xₜ, L^{(t, t+D)} (Xₜ, Wₜ)) of the parameter and the objective function in the optimization result storage unit 144.

Herein, the people flow simulator itself performs the simulation at all the time slots, and the simulator execution unit 141 determines the next input parameter Xₜ^{next} on the basis of the calculation result of the input parameter and the objective function from the execution result of the people flow simulator.

For example, in a case where Bayesian optimization is used as the optimization technique, the next input parameter is determined by using a probability model such as a Gaussian process. Specifically, the next input parameter determination unit 142 estimates a relational expression between the parameter Xₜ and the objective function value L^{(t, t+D)} (Xₜ, Wₜ) by, for example, the Gaussian process by using all the data stored in the optimization result storage unit 144.

When all the data is represented as follows,

Data={Xₜ_{ₗ},L^{(t,t+D)}(Xₜ_{ₗ},Wₜ))|l=1,2, . . . ,N}

an objective function value L^{(t, t+D)} (Xₜ, Wₜ) in a certain parameter Xₜ follows a Gaussian distribution having an average value μ(Xₜ) represented by the following equation and a variance σ(Xₜ) represented by the following equation.

μ( [symbol] )=k^{T}K^{T}Y [Math. 3]

Where a superscript T represents a transpose of a matrix, and a superscript “−1” represents an inverse matrix. In addition, in the equations, a character obtained by adding “\hat{ }” on a symbol (for example, X) may be hereinafter represented as \hat{ }X.

This kernel function may be changed according to a problem. A representative kernel includes a linear kernel, a Gaussian kernel, or the like (Nello Cristianini, John Shawa-Taylor, Tsuyoshi Okita (translator): Kernel Methods for Pattern Analysis (2010).).

σ( [symbol] )=k( [symbol] , [symbol] )−k^{T}K^{T}y [Math. 4]

Where

y=(L^{(t,t+D)}(Xₜ_{₁},Wₜ),L^{(t,t+D)}(Xₜ_{₂},Wₜ), . . . ,L^{(t,t+D)}(Xₜ_{_{N}},Wₜ))

Herein, k and K can be written as the following equations by using a function k(Xₜ, Xₜ′) referred to as a kernel function for defining a similarity between the parameters Xₜ and Xₜ′.

k=(k( [symbol] ,Xₜ_{₁}),k( [symbol] ,Xₜ_{₁}), . . . ,k( [symbol] ,Xₜ_{_{N}}))

K=(k(Xₘ,Xₙ))_{m,n=1}^{N} [Math. 5]

Then, the next input parameter determination unit 142 determines the parameter Xₜ^{next} that is to be input to the people flow simulator next according to the following equation (2).

$$\begin{matrix}[ Math . 6 ] & \\ {X}_{t}^{next} = {argmaxα ( \hat{{X}_{t} )}}_{\hat{{X}_{t}}} & ( 2 )\end{matrix}$$

Herein, α(\hat{ }Xₜ) is referred to as an acquisition function, and is an indicator for quantitatively evaluating a possibility that the parameter Xₜ provides a minimum value. The acquisition function α(\hat{ }Xₜ) is represented, for example, by using the average value μ(\hat{ }Xₜ) and the variance σ(\hat{ }Xₜ). In addition, a probability improvement (PI), an expectation value improvement (EI), or the like may be used for the acquisition function.

While the time slot t is set as the estimation target time slot, until a predetermined repetition ending condition is satisfied, the optimization control unit 143 repeats the execution by the simulator execution unit 141 and the determination by the next input parameter determination unit 142, and obtains an input parameter Xₜ* for optimizing the objective function value L^{(t, t+D)} (Xₜ, Wₜ).

Specifically, first, the optimization control unit 143 initializes the optimization result storage unit 144 into an empty set.

Next, the optimization control unit 143 repeats the processing in the simulator execution unit 141 and the processing in the next input parameter determination unit 142 in the time slot t until a count exceeds a maximum optimization execution count S.

The optimization control unit 143 inputs the parameter Xₜ^{next} obtained by the next input parameter determination unit 142 to the simulator execution unit 141 as the input parameter, and executes the simulation by the people flow simulator.

Then, when the repetition is ended, the optimization control unit 143 calculates the parameter Xₜ* at which the error is minimized among the input parameters stored in the optimization result storage unit 144 according to the following equation, and stores the parameter Xₜ* in the time slot optimization result storage unit 145. Herein, Data means the optimization result storage unit 144.

$$\begin{matrix}[ Math . 7 ] & \\ {X}_{t}^{⋆} = {argmin}_{{X}_{t} ∈ Data} {L}^{( t , t + D )} ( {X}_{t} , {W}_{t} ) & \end{matrix}$$

Then, the optimization control unit 143 initializes the optimization result storage unit 144 into an empty set, and performs similar processing while the next time slot t+1 is set as an estimation target time.

When the aforementioned processing is performed with regard to all the time slots (1 to T), the optimization control unit 143 calculates an optimal parameter by organizing data included in the time slot optimization result storage unit 145 as follows to be stored as an optimal parameter table.

X*=(X₁*,X₂*, . . . ,X_{T}*)

The calculated optimal parameter X* is output via an external output or the like.

The optimization result storage unit 144 stores the pair (Xₜ, L^{(t, t+D)} (Xₜ, Wₜ)) of the input parameter Xₜ and the objective function value L^{(t, t+D)} (Xₜ, Wₜ) in the time slot t which is obtained by the simulator execution unit 141.

In addition, when an instruction for initialization by the optimization control unit 143 is obtained, the optimization result storage unit 144 deletes all the stored (Xₜ, L^{(t, t+D)} (Xₜ, Wₜ)) into an empty set.

The time slot optimization result storage unit 145 stores the optimal parameter Xₜ* in the time slot t which is obtained by the optimization control unit 143.

<Action of the Path Specific Traffic Volume Estimation Device According to the Second Embodiment>

FIG. 8 is a flowchart illustrating a flow of the path specific traffic volume estimation processing by the path specific traffic volume estimation device 210. When the CPU 11 reads out the path specific traffic volume estimation program from the ROM 12 or the storage 14, and develops and executes the program in the RAM 13, the path specific traffic volume estimation processing is performed.

In step S201, the CPU 11 functioning as the path candidate generation unit 110 generates the path candidate list R by using the road network data G, the node set V and the node set U, the multiplying factor α, and the observation spot list M as the inputs.

In step S202, the CPU 11 obtains fields necessary for executing the simulation input by the input unit 15. The CPU 11 respectively obtains the maximum optimization execution count S, the number of time divisions J, a maximum repetition count R, and a time lag constant D which are input by the input unit 15.

In step S203, the CPU 11 sets the fields necessary for executing the simulation obtained in the aforementioned step S202.

In step S204, the CPU 11 sets the maximum optimization execution count S, the number of time divisions J, the maximum repetition count R, and the time lag constant D obtained in the aforementioned step S202.

In step S205, the CPU 11 functioning as the optimization control unit 143 initializes the optimization result storage unit 144 (Data) into an empty set.

In step S206, the CPU 11 sets r=1. Where r denotes a counter configured to count the number of repetitions of the optimization processing.

In step S207, the CPU 11 sets t=1. Where t denotes a counter configured to count the estimation target time slot.

In step S208, the CPU 11 functioning as the optimization execution unit 140 executes the optimization processing.

In step S209, the CPU 11 functioning as the optimization control unit 143 calculates the input parameter Xₜ* at which the error is minimized among the input parameters stored in the optimization result storage unit 144, and stores the input parameter Xₜ* in the time slot optimization result storage unit 145.

In step S210, the CPU 11 sets t=t+1.

In step S211, the CPU 11 sets r=r+1.

In step S212, the CPU 11 functioning as the optimization control unit 143 determines whether or not r is higher than the maximum repetition count R. In a case where r is not higher than the maximum repetition count R, in step S213, the CPU 11 functioning as the optimization control unit 143 determines whether or not r is higher than the number of time divisions J.

On the other hand, in a case where r is higher than J, in step S214, the CPU 11 functioning as the optimization control unit 143 reads out the pair (Xₜ*, L^{(t, t+D)} (Xₜ, Wₜ)), which is stored in the time slot optimization result storage unit 145, of the input parameter Xₜ* and the objective function value L^{(t, t+D)} (Xₜ*, Wₜ) to store the pair in the optimization result storage unit 144, and repeats the processing in steps S208 to S212 again.

In a case where r is not higher than J, in step S215, the CPU 11 functioning as the optimization control unit 143 initializes the optimization result storage unit 144 into an empty set, and repeats the processing in steps S208 to S214 again.

In a case where r is higher than R, in step S216, the CPU 11 functioning as the optimization control unit 143 organizes the data included in the time slot optimization result storage unit 145 to generate the optimal parameter as follows to be stored in the optimal parameter table.

X*=(X₁*,X₂*, . . . ,X_{T}*)

In step S217, the CPU 11 functioning as the optimization control unit 143 outputs the generated optimal parameter X* by the display unit 16, and the path specific traffic volume estimation processing is ended.

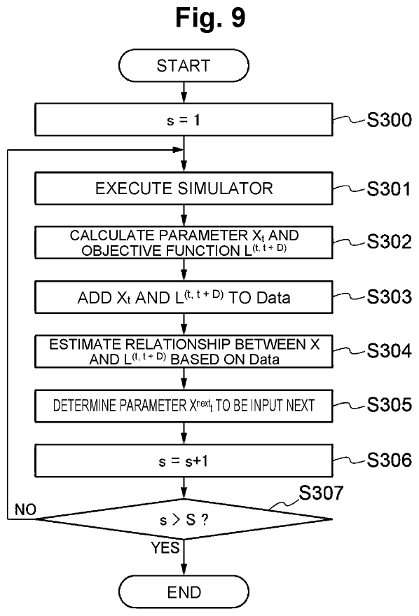

Herein, the optimization processing in the aforementioned step S208 will be described. FIG. 9 is a flowchart illustrating an optimization processing routine.

In step S300, the CPU 11 sets s=1. Herein, s denotes a counter configured to count the number of times the optimization is performed.

In step S301, the CPU 11 functioning as the simulator execution unit 141 executes a simulation with regard to each of the plurality of paths Rᵢ in the actual environment in each time slot t on the basis of the input parameter Xₜ in which the number of the observation objects passing through the path Rᵢ in the estimation target time slot t is set as the element.

In step S302, the CPU 11 functioning as the simulator execution unit 141 calculates, from the simulation result in the aforementioned step S301, an objective function value L^{(t, t+D)} (Xₜ, Wₜ) representing an observation error between the calculation value Wₜ, ᵢYₜ, i^{mas} related to the agent at each of the observation spots and the observation value Wₜ, ᵢYₜ, i^{obsv} in the actual environment in the predetermined number of time slots including the estimation target time slot t and the next time slot t+D after the estimation target time slot.

In step S303, the CPU 11 functioning as the simulator execution unit 141 adds the pair (Xₜ, L^{(t, t+D)} (Xₜ, Wₜ)) of the input parameter Xₜ obtained and calculated in the aforementioned step S302 and the objective function value L^{(t, t+D)} (Xₜ, Wₜ) to the optimization result storage unit 144.

In step S304, the CPU 11 functioning as the next input parameter determination unit 142 estimates a relational expression between the parameter Xₜ and the objective function value L^{(t, t+D)} (Xₜ, Wₜ) by using all the data in the optimization result storage unit 144.

In step S305, the CPU 11 functioning as the next input parameter determination unit 142 determines the parameter Xₜ^{next} that is to be input to the people flow simulator next according to the equation (2).

In step S306, the CPU 11 sets s=s+1.

In step S307, the CPU 11 functioning as the optimization control unit 143 determines whether or not s is higher than the maximum optimization execution count S.

In a case where s is not higher than the maximum optimization execution count S, the CPU 11 returns to step S301, and repeats the processing in steps S301 to S306. In a case where s is higher than the maximum optimization execution count S, the optimization processing is ended.

As described above, the path specific traffic volume estimation device of the second embodiment executes a simulation in which the agents representing the observation objects move at each time point on the basis of the input parameter configured by the observation value data, the observation spot specific reliability data, the path candidate list, and the traffic volume of the observation objects at each time point at each of the path candidates. The observation value data is the number of observation objects at each time point at each of the plurality of observation spots. The observation spot specific reliability data is the reliability of the observation value data at each time point at each of the plurality of observation spots. The error between the calculation value obtained by estimating the number of the agents at each time point at each of the plurality of observation spots and the observation value data is calculated by using the observation spot specific reliability data. The next input parameter for determining the next input parameter is determined on the basis of the input parameter and the error. The traffic volume of the observation objects at each time point at each of the path candidates is estimated by repeating the execution of the simulation and the determination of the next parameter until the repetition ending condition is satisfied. According to this, even under a situation where the reliability of the observation value data varies for each time slot or each observation spot, the path specific traffic volume can be precisely estimated.

In addition, the objective function representing the observation error between the calculation value related to the agent at each of the observation spots and the observation value in the actual environment in the predetermined number of time slots including the estimation target time slot and the next time slot after the estimation target time slot is calculated from the simulation result. According to this, even under a situation where the time lag occurs, the path specific traffic volume can be precisely estimated.

It should be noted that the path specific traffic volume estimation processing executed when the CPU reads software (program) may be executed by various processors other than the CPU according to the aforementioned respective embodiments. As the processors in this case, a programmable logic device (PLD) having a circuit configuration that is changeable after manufacturing such as a field-programmable gate array (FPGA), a dedicated electric circuit serving as a processor having a dedicatedly designed circuit configuration configured to execute specific processing such as an application specific integrated circuit (ASIC), and the like are exemplified. In addition, the path specific traffic volume estimation processing may be executed by one of these various processors, or executed by a combination of the same type or different types of two or more processors (for example, a combination of a plurality of FPGAs, a CPU and FPGA, and the like). In addition, a hardware-like structure of these various processors is, more specifically, an electric circuit obtained by combining circuit devices such as semiconductor devices.

In addition, according to the aforementioned respective embodiments, the mode has been described in which the path specific traffic volume estimation program is stored (installed) in the storage 14 in advance, but is not limited to this. The program may be provided in a mode in which the program is stored on a non-transitory storage medium such as a compact disk read only memory (CD-ROM), a digital versatile disk read only memory (DVD-ROM), and a universal serial bus (USB) memory. In addition, a mode may be adopted in which the program is downloaded from an external device via a network.

With regard to the aforementioned embodiments, the following supplements will be further disclosed.

(Supplementary Item 1)

A path specific traffic volume estimation device including:

a memory; and

at least one processor connected to the memory, in which

the processor is configured to estimate a path specific traffic volume corresponding to a traffic volume of observation objects at each time point at each of path candidates on the basis of observation value data that represents the number of the observation objects at each time point at each of a plurality of observation spots, observation spot specific reliability data that represents a reliability of the observation value data at each time point at each of the plurality of observation spots, and a path candidate list that represents a set of the path candidates through which the observation objects move.

(Supplementary Item 2)

A path specific traffic volume estimation device including:

a memory; and

at least one processor connected to the memory, in which

the processor is configured to execute a simulation in which agents representing observation objects move at each time point on the basis of an input parameter configured by observation value data that represents the number of the observation objects at each time point at each of a plurality of observation spots, observation spot specific reliability data that represents a reliability of the observation value data at each time point at each of the plurality of observation spots, a path candidate list that represents a set of path candidates through which the observation objects move, and a traffic volume of the observation objects at each time point at each of the path candidates, and calculate, by using the observation spot specific reliability data, an error between a calculation value obtained by estimating the number of the agents at each time point at each of the plurality of observation spots and the observation value data,

determine a next input parameter on the basis of the input parameter and the error, and

estimate the traffic volume of the observation objects at each time point at each of the path candidates by repeating, until a predetermined repetition ending condition is satisfied, the execution of the simulation and the determination of the next input parameter.

(Supplementary Item 3)

A non-transitory storage medium storing a program that can be executed by a computer to execute path specific traffic volume estimation processing,

the path specific traffic volume estimation processing including:

estimating a path specific traffic volume corresponding to a traffic volume of observation objects at each time point at each of path candidates on the basis of observation value data that represents the number of the observation objects at each time point at each of a plurality of observation spots, observation spot specific reliability data that represents a reliability of the observation value data at each time point at each of the plurality of observation spots, and a path candidate list that represents a set of the path candidates through which the observation objects move.

(Supplementary Item 4)

A non-transitory storage medium storing a program that can be executed by a computer to execute path specific traffic volume estimation processing,

the path specific traffic volume estimation processing including:

executing a simulation in which agents representing observation objects move at each time point on the basis of an input parameter configured by observation value data that represents the number of the observation objects at each time point at each of a plurality of observation spots, observation spot specific reliability data that represents a reliability of the observation value data at each time point at each of the plurality of observation spots, a path candidate list that represents a set of path candidates through which the observation objects move, and a traffic volume of the observation objects at each time point at each of the path candidates, and calculating, by using the observation spot specific reliability data, an error between a calculation value obtained by estimating the number of the agents at each time point at each of the plurality of observation spots and the observation value data;

determining a next input parameter on the basis of the input parameter and the error; and

estimating the traffic volume of the observation objects at each time point at each of the path candidates by repeating, until a predetermined repetition ending condition is satisfied, the execution of the simulation and the determination of the next input parameter.

### REFERENCE SIGNS LIST

10, 210 Path specific traffic volume estimation device
14 Storage
15 Input unit
16 Display unit
17 Communication interface
19 Bus
110 Path candidate generation unit
120 Routing matrix generation unit
120 Optimization processing unit
130 Path specific traffic volume estimation unit
140 Optimization execution unit
141 Simulator execution unit
142 Next input parameter determination unit
143 Optimization control unit
144 Optimization result storage unit
145 Time slot optimization result storage unit

1. A path specific traffic volume estimation device comprising:
a path specific traffic volume estimator configured to estimate a path specific traffic volume corresponding to a traffic volume of observation objects at each time point at each of path candidates on the basis of observation value data that represents the number of the observation objects at each time point at each of a plurality of observation spots, observation spot specific reliability data that represents a reliability of the observation value data at each time point at each of the plurality of observation spots, and a path candidate list that represents a set of the path candidates through which the observation objects move.

2. The path specific traffic volume estimation device according to claim 1,
wherein the path specific traffic volume estimator estimates the traffic volume of the observation objects at each time point at each of the path candidates by minimizing an objective function, and
wherein the objective function is represented using the observation value data, the observation spot specific reliability data, a routing matrix representing a relationship between the path candidates and the observation spots, and the traffic volume of the observation objects.

3. The path specific traffic volume estimation device according to claim 1, further comprising:
a path candidate generator configured to generate the path candidate list on the basis of road network data including a set of nodes on a road network and a set of links that connect nodes to each other, a set of nodes corresponding to origins of movements of the observation objects, a set of nodes corresponding to destinations of the movements of the observation objects, and the plurality of observation spots.

4. (canceled)

5. A computer-implemented method for estimating a path specific traffic volume, comprising:
causing a path specific traffic volume estimator to estimate a path specific traffic volume corresponding to a traffic volume of observation objects at each time point at each of path candidates on the basis of observation value data that represents the number of the observation objects at each time point at each of a plurality of observation spots, observation spot specific reliability data that represents a reliability of the observation value data at each time point at each of the plurality of observation spots, and a path candidate list that represents a set of the path candidates through which the observation objects move.

6. A computer-implemented method for estimating a path specific traffic volume, the method comprising:
causing a simulator to perform a simulation in which agents representing observation objects move at each time point on the basis of an input parameter configured by observation value data that represents the number of the observation objects at each time point at each of a plurality of observation spots, observation spot specific reliability data that represents a reliability of the observation value data at each time point at each of the plurality of observation spots, a path candidate list that represents a set of path candidates through which the observation objects move, and a traffic volume of the observation objects at each time point at each of the path candidates, and calculate, by using the observation spot specific reliability data, an error between a calculation value obtained by estimating the number of the agents at each time point at each of the plurality of observation spots and the observation value data;
causing a next input parameter determiner to determine a next input parameter on the basis of the input parameter and the error; and
causing an optimization estimator to estimate the traffic volume of the observation objects at each time point at each of the path candidates by repeating, until a predetermined repetition ending condition is satisfied, the performing the simulation by the simulator and the determination of the next input parameter by the next input parameter determiner.

7-8. (canceled)

9. The path specific traffic volume estimation device according to claim 2, further comprising:
a path candidate generator configured to generate the path candidate list on the basis of road network data including a set of nodes on a road network and a set of links that connect nodes to each other, a set of nodes corresponding to origins of movements of the observation objects, a set of nodes corresponding to destinations of the movements of the observation objects, and the plurality of observation spots.

10. The computer-implemented method according to claim 5,
wherein the path specific traffic volume estimator estimates the traffic volume of the observation objects at each time point at each of the path candidates by minimizing an objective function, and
wherein the objective function is represented using the observation value data, the observation spot specific reliability data, a routing matrix representing a relationship between the path candidates and the observation spots, and the traffic volume of the observation objects.

11. The computer-implemented method according to claim 5, further comprising:
generating, by a path candidate generator, the path candidate list on the basis of road network data including a set of nodes on a road network and a set of links that connect nodes to each other, a set of nodes corresponding to origins of movements of the observation objects, a set of nodes corresponding to destinations of the movements of the observation objects, and the plurality of observation spots.

12. The computer-implemented method according to claim 10, further comprising:
generating, by a path candidate generator, the path candidate list on the basis of road network data including a set of nodes on a road network and a set of links that connect nodes to each other, a set of nodes corresponding to origins of movements of the observation objects, a set of nodes corresponding to destinations of the movements of the observation objects, and the plurality of observation spots.
